(19) United States
(12) Patent Application Publication
(10) Pub. No.: US 2025/0174791 A1
(43) Pub. Date: May 29, 2025

(54) POLYMER-BASED TRACTION BATTERY ENCLOSURE AND METHOD OF FORMING SAME

(71) Applicant: Ford Global Technologies, LLC, Dearborn, MI (US)

(72) Inventors: Patrick Daniel Maguire, Ann Arbor, MI (US); Mohammadreza Eftekhari, Novi, MI (US); Charles C. Poon, Canton, MI (US)

(21) Appl. No.: 18/914,414

(22) Filed: Oct. 14, 2024

Related U.S. Application Data
(60) Provisional application No. 63/603,512, filed on Nov. 28, 2023.

(51) Int. Cl. H01M 50/227; B29C 51/10; B29C 51/12; B29L 31/00; B60K 1/04; B60L 50/60; B60L 50/64; H01M 10/613; H01M 10/625; H01M 10/6568; H01M 50/209; H01M 50/249

(52) U.S. Cl. CPC H01M 50/227; B29C 51/10; B29C 51/12; B60K 1/04; B60L 50/64; B60L 50/66; H01M 10/613; H01M 10/625; H01M 10/6568; H01M 50/209; H01M 50/249; B29L 2031/7146; B60K 2001/0438; H01M 2220/20

(57) ABSTRACT

A battery assembly includes at least one enclosure structure that is thermoformed about a battery assembly of a battery pack. A method of enclosing a battery assembly can include placing a sheet of material adjacent a battery assembly of a battery pack; and thermoforming the sheet of material about the battery assembly to provide an enclosure structure for the battery assembly.

### CROSS-REFERENCE TO RELATED APPLICATIONS

This application claims the benefit of U.S. Provisional Application No. 63/603,512, which was filed on 28 Nov. 2023 and is incorporated herein by reference.

### BACKGROUND

Enclosures for traction battery packs can include a tray and a cover. The tray can be secured to the cover via mechanical fasteners. The enclosure facilitates electrical isolation of traction battery pack components, helps to protect those components against environmental factors, and supports the traction battery. The enclosures are typically metal or metal-alloy.

### SUMMARY

In some aspects, the techniques described herein relate to a battery assembly, including: at least one enclosure structure that is thermoformed about a battery assembly of a battery pack.

In some aspects, the techniques described herein relate to a battery assembly, wherein the battery assembly includes a plurality of battery cells.

In some aspects, the techniques described herein relate to a battery assembly, wherein the battery assembly further includes a plurality of busbars, and at least one thermal exchange plate.

In some aspects, the techniques described herein relate to a battery assembly, wherein the battery assembly is a positive mold for the at least one enclosure structure.

In some aspects, the techniques described herein relate to a battery assembly, wherein the at least one enclosure structure is vacuum thermoformed about the battery assembly.

In some aspects, the techniques described herein relate to a battery assembly, wherein the at least one enclosure structure includes a first enclosure structure and a second enclosure structure that together enclose the battery assembly.

In some aspects, the techniques described herein relate to a battery assembly, wherein at least one electrical interface extends through the at least one enclosure structure to the battery assembly.

In some aspects, the techniques described herein relate to a battery assembly, wherein a coolant inlet, a coolant outlet, or both extend through the at least one enclosure structure.

In some aspects, the techniques described herein relate to a battery assembly, further including the battery assembly and a structural support assembly, the structural support assembly configured to support the at least one enclosure structure thermoformed about the battery assembly.

In some aspects, the techniques described herein relate to a battery assembly, wherein the structural support assembly is configured to support the battery assembly and the at least one enclosure structure.

In some aspects, the techniques described herein relate to a battery assembly, wherein the structural support assembly is configured to be fastened to an underside of an electric vehicle.

In some aspects, the techniques described herein relate to a battery assembly, wherein the battery assembly includes a plurality of battery cells that are immersion cooled.

In some aspects, the techniques described herein relate to a battery assembly, wherein the at least one enclosure structure contains an coolant.

In some aspects, the techniques described herein relate to a battery assembly, wherein the at least one enclosure structure provides a fluid boundary for a fluid coolant.

In some aspects, the techniques described herein relate to a battery assembly, wherein the battery pack is a battery pack of an electrified vehicle.

In some aspects, the techniques described herein relate to a method of enclosing a battery assembly, including: placing a sheet of material adjacent a battery assembly of a battery pack; and thermoforming the sheet of material about the battery assembly to provide an enclosure structure for the battery assembly.

In some aspects, the techniques described herein relate to a method, wherein the thermoforming includes vacuum thermoforming.

In some aspects, the techniques described herein relate to a method, further including using the battery assembly as a positive mold for the enclosure structure during the thermoforming.

In some aspects, the techniques described herein relate to a method, wherein the battery assembly includes a plurality of battery cells.

In some aspects, the techniques described herein relate to a method, wherein the enclosure assembly and the battery assembly are configured to be supported by a structural support assembly that is fastened to an underside of an electrified vehicle.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIGS. 1A and 1B schematically illustrates an example of thermoforming a sheet of material.

FIG. 2 illustrates a plurality of polymer-based sheets and a battery assembly.

FIG. 3 illustrates the polymer-based sheets after thermoforming the sheets into an enclosure that encloses the battery assembly according to an exemplary aspect of the present disclosure.

FIGS. 4A to 4D illustrates stages in a method of enclosing a battery assembly within an enclosure provided by heat-formed sheets according to another exemplary aspect of the present disclosure.

FIGS. 5A and 5B illustrates stages in a method of enclosing a battery assembly within an enclosure provided by heat-formed sheets according to yet another exemplary aspect of the present disclosure.

FIGS. 6A and 6B illustrates stages in a method of enclosing a battery assembly within an enclosure provided by heat-formed sheets according to still another exemplary aspect of the present disclosure.

FIGS. 7A and 7B illustrates a variation of the embodiment of FIGS. 6A and 6B.

### DETAILED DESCRIPTION

This disclosure is directed toward a battery pack enclosure manufactured using a thermoforming process. The battery pack enclosure can be polymer-based. The battery pack enclosure can have a reduced packaging footprint and overall weight when compared to other enclosure types, which are typically metal or metal allow.

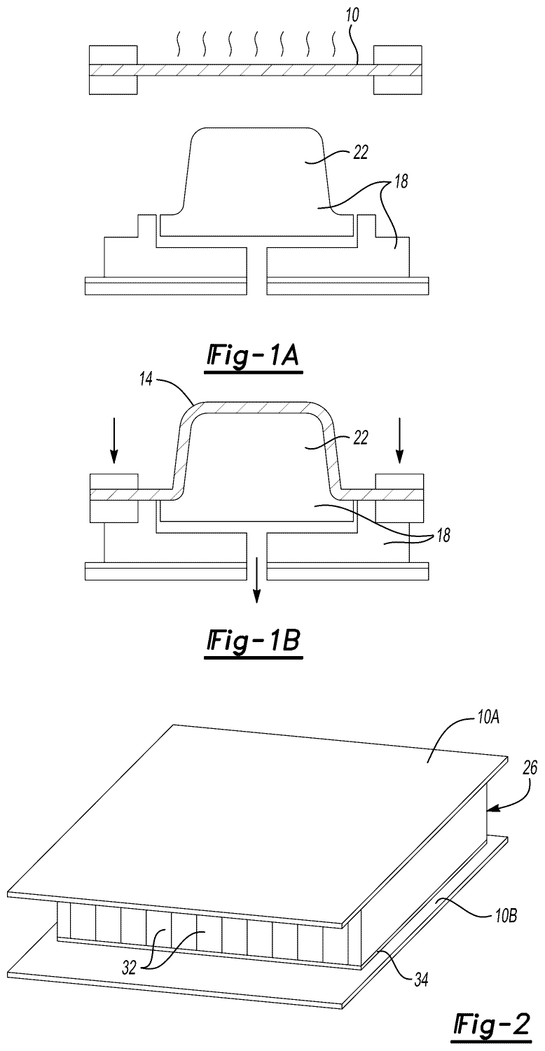

With reference to FIGS. 1A and 1B, an example thermoforming process forms a polymer-based sheet of material 10 into a desired geometry 14 by drawing a vacuum within a mold. The sheet of material 10 can be formed over a positive mold 22 as the vacuum is drawn. This can be considered vacuum-forming or vacuum molding. In other examples, the thermoforming process is an overmolding process.

The sheet of material 10 can be placed near the positive mold 22 and heated to soften the sheet of material 10 prior to forming the sheet of material 10 over the positive mold 22. The sheet of material 10 can be a polymer-based material, such as polycarbonate (PC), polypropylene (PP), high-density polyethylene (HDPE), polyethylene terephthalate (PET), acrylonitrile butadiene styrene (ABS), or some combination of these. Another type of polymer-based material could be used in other examples.

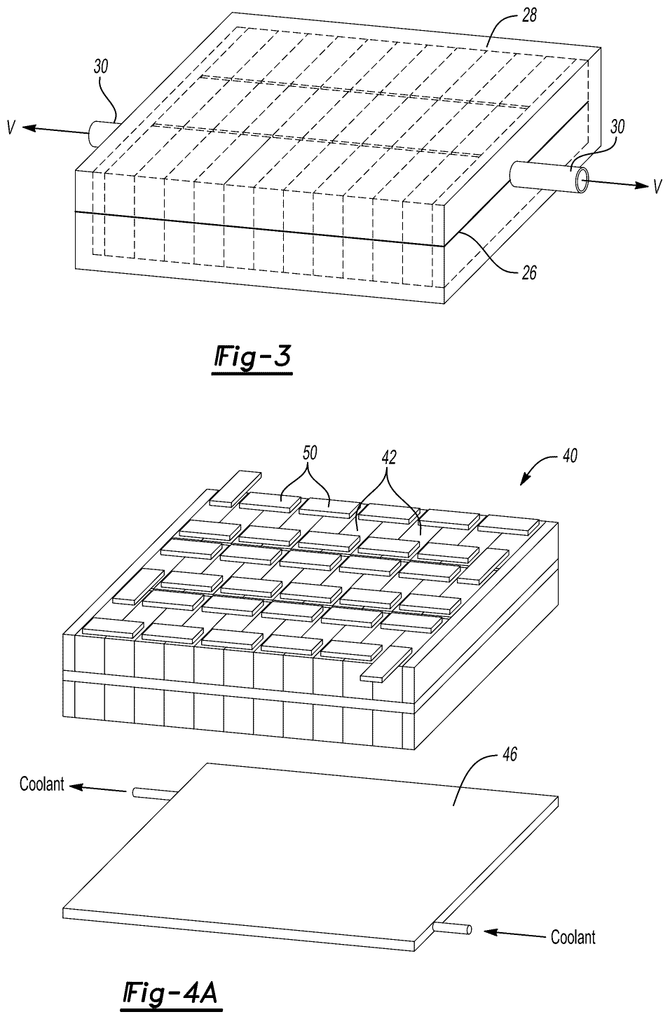

With reference to FIGS. 2 and 3, an example thermoforming process forms a sheet of material 10A and a sheet of material 10B about a battery assembly 26 to provide a thermoformed enclosure 28. After thermoforming the sheet of material 10A and the sheet of material 10B around the battery assembly 26, the sheet of material 10A and the sheet of material 10B are enclosure structures that together enclose the battery assembly 26. The battery assembly 26 effectively acts as the positive mold 22 (FIGS. 1A and 1B) during the thermoforming.

The sheets of material 10A, 10B are polymer-based in this example. Although the thermoformed enclosure 28 is formed from two sheets of material 10A, 10B in this example, other enclosures could be formed utilizing more than two sheets of material.

In this example, the sheets of material 10A and 10B are vacuum formed over the battery assembly 26 to provide the thermoformed enclosure 28 about the battery assembly 26 as shown in FIG. 3. Vacuum ducts or vents 30 can be used to draw the vacuum V between the sheets of material 10A and 10B, which effectively shrink-wraps the battery assembly 26 with the sheets of material 10A and 10B. In other examples, other thermoforming process that do not draw a vacuum could be used to form the sheets of material 10A and 10B into the thermoformed enclosure 28.

The example battery assembly 26 is a matrix of individual battery cells 32 arranged in individual arrays and disposed upon a thermal exchange plate 34. The thermoformed enclosure 28 contains the battery assembly 26 and can closely track a profile of the battery assembly 26 by maintaining no or very little clearance between the thermoformed enclosure 28 and components of the battery assembly 26.

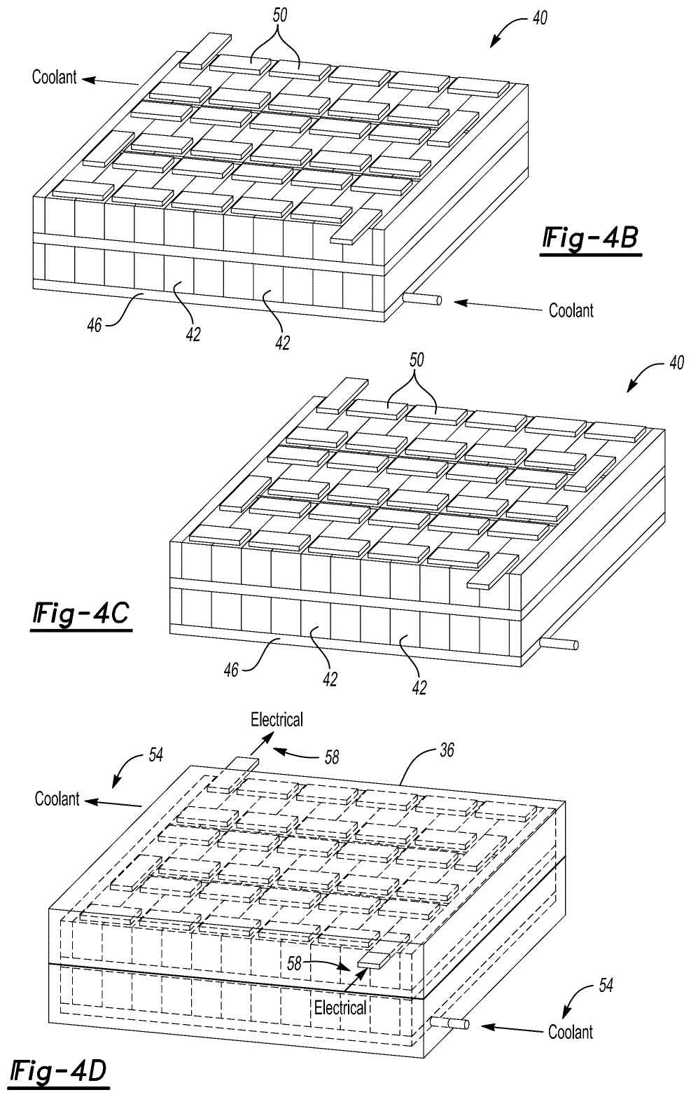

With reference now to FIGS. 4A to 4D, another example thermoformed enclosure 36 can be positioned around a battery assembly 40 having a plurality of individual battery cells 42 arranged in arrays and disposed upon a thermal exchange plate 46. The battery assembly 40 can further include electrical connectors 50, such as busbars, that electrically connect to the battery cells 42. Sensors, such as temperature and pressure sensors, could also be disposed adjacent the battery cells 42 and incorporated in the battery assembly 40.

Within the battery assembly 40, the battery cells 42 can be bound to facilitate management of internal forces caused by the one or more of the battery cells 42 swelling or other causes. The thermoformed enclosure 36 can be formed about the battery assembly 40 while providing coolant interfaces 54 and electrical interfaces 58 that extend through the thermoformed enclosure 36. In this example, but for the coolant interfaces 54 and electrical interfaces 58, the battery assembly 40 is environmentally separated and hermetically sealed from an area outside the thermoformed enclosure 36. This can, among other things, shield the battery assembly 40 from debris.

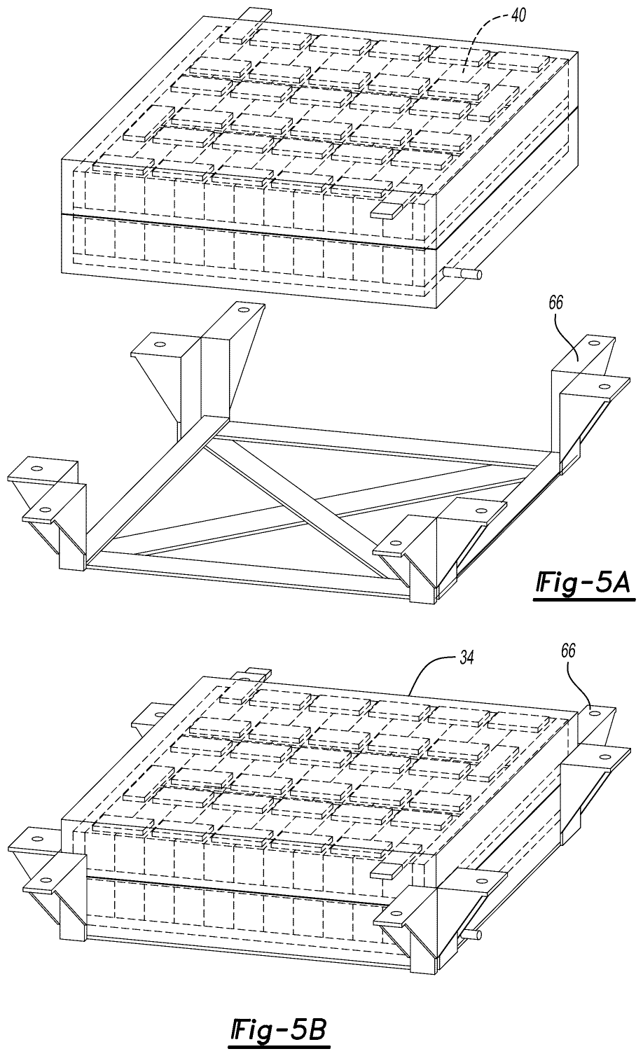

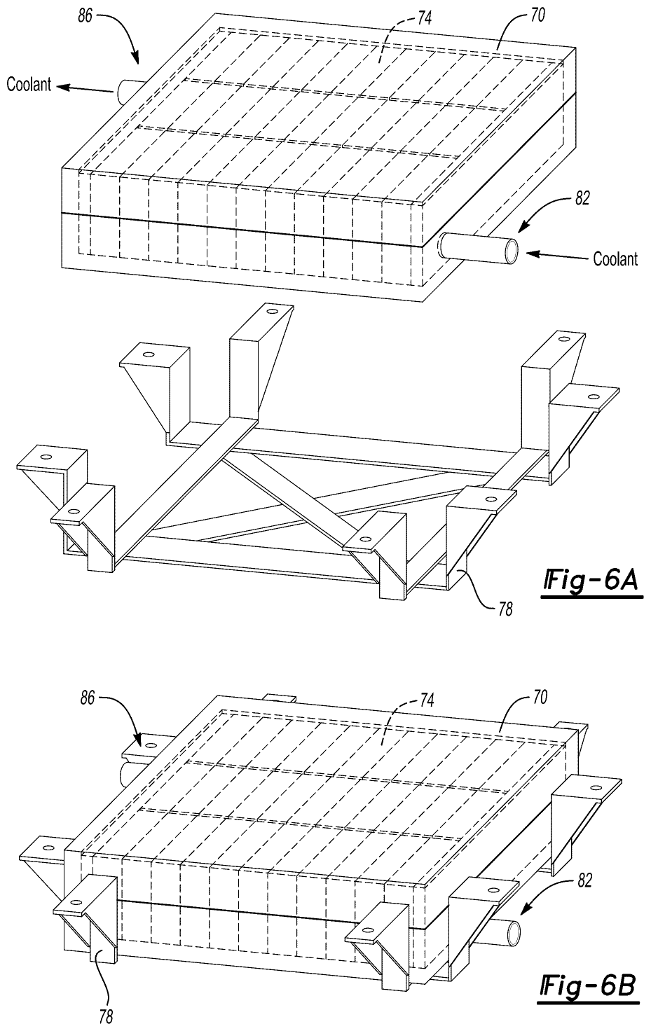

With reference now to FIGS. 5A and 5B, the thermoformed enclosure 36 containing the battery assembly 40 can be supported within an electrified vehicle utilizing a structural support assembly 66. The structural support assembly 66 can be a metal or metal-alloy. As can be appreciated, the structural support assembly 66 utilizes less metal or metal-alloy material than if the entire thermoformed enclosure 36 were made of metal.

The structural support assembly 66 can be mechanically fastened to an underside of an electrified vehicle to support the thermoformed enclosure 36 and the battery assembly 40 contained within the thermoformed enclosure 36. The structural support assembly 66 can, in addition to supporting the battery assembly 40, protect the battery assembly 40 and the thermoformed enclosure 36 from external loads resulting from movements of a vehicle, contact with ground, contact with debris, etc.

With reference now to FIGS. 6A and 6B, another exemplary embodiment can include a polymer-based, thermoformed enclosure 70 that accommodates a battery assembly 74 and is supported by a support structure 78. The battery assembly 74 is immersion cooled. The thermoformed enclosure 70 can contain fluid utilized when immersion cooling the battery assembly 74. That is, the thermoformed enclosure 70 can be used as at least part of a fluid boundary for the fluid that is circulated during immersion cooling. A coolant inlet 82 can extend through an area of the thermoformed enclosure 70. A coolant outlet 86 can extend through another area of the thermoformed enclosure 70.

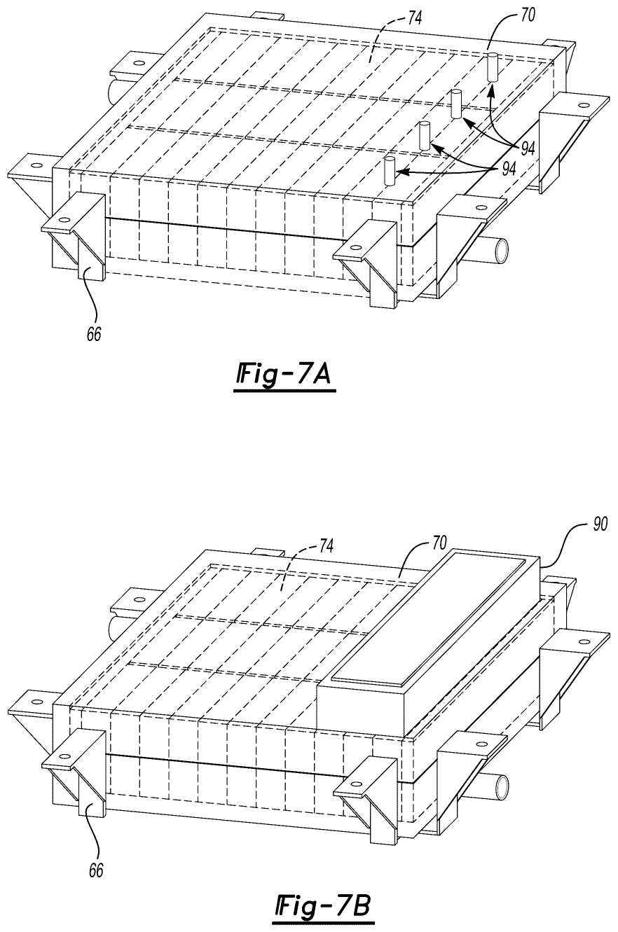

FIGS. 7A and 7B shows a variation of the embodiment of FIGS. 6A and 6B, or any of the other embodiments of this disclosure. In the variation of FIGS. 7A and 7B, a serviceable electronic box 90 is coupled to the battery assembly 74 within the thermoformed enclosure 70. This box 90 can have BEC, BECM, Fuses, DCDC converter or other such components. Electrical connections 94 between the battery assembly 74 and the box 90 can pass through the thermoformed enclosure 70 and connect to the components in the e-box 90. These electrical connections 94 along with the coolant inlet 82 and the coolant outlet 86 can be sealed to the enclosure 70.

Features of the disclosed examples include a battery pack enclosure formed from a polymer-based material that is formed into a shape of the enclosure from a heat-formed polymer-based sheet. The resulting thermoformed plastic enclosure can effectively hermetically seal desired battery assemblies. A package size for the battery assembly and its enclosure can be reduced as the battery pack enclosure is effectively shrink-wrapped to the contained battery assembly. In some examples, an immersion cooling fluid can pass through the battery assembly contained by the enclosure.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery assembly, comprising:
at least one enclosure structure that is thermoformed about a battery assembly of a battery pack.

2. The battery assembly of claim 1, wherein the battery assembly includes a plurality of battery cells.

3. The battery assembly of claim 1, wherein the battery assembly further includes a plurality of busbars, and at least one thermal exchange plate.

4. The battery assembly of claim 1, wherein the battery assembly is a positive mold for the at least one enclosure structure.

5. The battery assembly of claim 1, wherein the at least one enclosure structure is vacuum thermoformed about the battery assembly.

6. The battery assembly of claim 1, wherein the at least one enclosure structure comprises a first enclosure structure and a second enclosure structure that together enclose the battery assembly.

7. The battery assembly of claim 1, wherein at least one electrical interface extends through the at least one enclosure structure to the battery assembly.

8. The battery assembly of claim 1, wherein a coolant inlet, a coolant outlet, or both extend through the at least one enclosure structure.

9. The battery assembly of claim 1, further comprising the battery assembly and a structural support assembly, the structural support assembly configured to support the at least one enclosure structure thermoformed about the battery assembly.

10. The battery assembly of claim 9, wherein the structural support assembly is configured to support the battery assembly and the at least one enclosure structure.

11. The battery assembly of claim 9, wherein the structural support assembly is configured to be fastened to an underside of an electric vehicle.

12. The battery assembly of claim 1, wherein the battery assembly comprises a plurality of battery cells that are immersion cooled.

13. The battery assembly of claim 1, wherein the at least one enclosure structure contains an coolant.

14. The battery assembly of claim 1, wherein the at least one enclosure structure provides a fluid boundary for a fluid coolant.

15. The battery assembly of claim 1, wherein the battery pack is a battery pack of an electrified vehicle.

16. A method of enclosing a battery assembly, comprising:
placing a sheet of material adjacent a battery assembly of a battery pack; and
thermoforming the sheet of material about the battery assembly to provide an enclosure structure for the battery assembly.

17. The method of claim 16, wherein the thermoforming comprises vacuum thermoforming.

18. The method of claim 16, further comprising using the battery assembly as a positive mold for the enclosure structure during the thermoforming.

19. The method of claim 16, wherein the battery assembly comprises a plurality of battery cells.

20. The method of claim 19, wherein the enclosure assembly and the battery assembly are configured to be supported by a structural support assembly that is fastened to an underside of an electrified vehicle.
